(19) United States
(12) Patent Application Publication
(10) Pub. No.: US 2009/0083148 A1
(43) Pub. Date: Mar. 26, 2009

(54) System and method for facilitating content transfers between client devices in an electronic network

(75) Inventors: Paul Hwang, Burbank, CA (US); Nikolaos Georgis, San Diego, CA (US)

Correspondence Address: Gregory J. Koerner;Redwood Patent Law, 1291 East Hillsdale Boulevard, Suite 205, Foster City, CA, 94404, US

(73) Assignees: Sony Corporation; Sony Electronics, Inc.

(21) Appl. No.: 11/904,192

(22) Filed: Sep. 26, 2007

(51) Int. Cl. G06Q 30/00

(52) U.S. Cl. 705/14

(57) ABSTRACT

A system and method for facilitating content distribution in an electronic network includes a peer-to-peer network of client devices. The client devices are configured to perform content transfers for optimally exchanging desired content items over the peer-to-peer network. A tracking server gathers client statistics, such as content upload totals, by monitoring the various client devices. A rewards manager of the tracking server encourages content transfers between client devices by generating client rewards to the client devices based upon the pre-defined client statistics gathered from the client devices.

### BACKGROUND SECTION

1. Field of the Invention

This invention relates generally to techniques for managing electronic information, and relates more particularly to a system and method for facilitating content transfers between client devices in an electronic network.

2. Description of the Background Art

Implementing effective methods for managing electronic information is a significant consideration for designers and manufacturers of contemporary electronic devices. However, effectively managing information utilized by devices in an electronic network may create substantial challenges for system designers. For example, enhanced demands for increased device functionality and performance may require more system processing power and require additional software resources. An increase in processing or software requirements may also result in a corresponding detrimental economic impact due to increased production costs and operational inefficiencies.

Furthermore, enhanced device capability to perform various advanced data management operations may provide additional benefits to a system user, but may also place increased demands on the control and management of various system components. For example, an enhanced electronic network device that effectively manages electronic content information may benefit from an effective implementation because of the large amount and complexity of the digital data involved.

Due to growing demands on system resources and substantially increasing data magnitudes, it is apparent that developing new techniques for managing information in electronic networks is a matter of concern for related electronic technologies. Therefore, for all the foregoing reasons, developing effective techniques for managing information in electronic networks remains a significant consideration for designers, manufacturers, and users of contemporary electronic devices.

### SUMMARY

In accordance with the present invention, a system and method for facilitating content transfers between client devices in an electronic network are disclosed. In one embodiment, one or more requesting client devices send corresponding content location requests to a tracking server. The tracking server responds by returning content locations on specified target client devices to the requesting client devices. The requesting client devices then send content transfer requests for the desired content items to selected target client devices. The selected target client devices responsively upload the requested content items to the requesting client devices.

In the present embodiment, a statistics module of the tracking server gathers client statistics from the various client devices. The client statistics may include any relevant information including, but not limited to, the number of megabytes of content information transferred from individual client devices to other client devices. In the present embodiment, a rewards manager of the tracking server may periodically generate statistics reports at predetermined and selectable time intervals. When a statistics report is triggered, the rewards manager analyzes the various information currently compiled in the client statistics. The rewards manager then generates the statistics reports based upon the specific information gathered and stored in the client statistics.

The rewards manager then may perform a conversion procedure to generate specific client rewards from the information represented in the statistics reports. The rewards manager notifies the respective client devices regarding their individual client rewards. Finally, the device users of the various client devices may utilize their respective client rewards in any desired manner. For at least the foregoing reasons, the present invention therefore provides an improved system and method for facilitating content transfers between client devices in an electronic network.

### BRIEF DESCRIPTION OF THE DRAWINGS

FIG. 1A is a block diagram of an electronic network, in accordance with one embodiment of the present invention;

FIG. 1B is a block diagram of the peer-to-peer network of FIG. 1A, in accordance with one embodiment of the present invention;

FIG. 2 is a block diagram for one embodiment of the tracking server of FIG. 1, in accordance with the present invention;

FIG. 3 is a block diagram for one embodiment of the server memory of FIG. 2, in accordance with the present invention;

FIG. 4 is a diagram illustrating a segmented content preloading procedure, in accordance with one embodiment of the present invention;

FIG. 5 is a block diagram for one embodiment of a client device from FIG. 1A, in accordance with the present invention;

FIG. 6 is a block diagram for one embodiment of the device memory of FIG. 5, in accordance with the present invention;

FIG. 7 is a block diagram for one embodiment of the client statistics from FIG. 3, in accordance with the present invention;

FIG. 8 is a block diagram for one embodiment of a statistics report from FIG. 3, in accordance with the present invention;

FIG. 9 is a block diagram for one embodiment of the client rewards from FIG. 3, in accordance with the present invention; and

FIGS. 10A, 10B, and 10C are a flowchart of method steps for facilitating content transfers between client devices, in accordance with one embodiment of the present invention.

### DETAILED DESCRIPTION

The present invention relates to an improvement in electronic information management techniques. The following description is presented to enable one of ordinary skill in the art to make and use the invention, and is provided in the context of a patent application and its requirements. Various modifications to the disclosed embodiments will be readily apparent to those skilled in the art, and the generic principles herein may be applied to other embodiments. Therefore, the present invention is not intended to be limited to the embodiments shown, but is to be accorded the widest scope consistent with the principles and features described herein.

The present invention comprises a system and method for facilitating content distribution in an electronic network, and includes a peer-to-peer network of client devices. The client devices are configured to perform content transfers for optimally exchanging desired content items over the peer-to-peer network. A tracking server gathers client statistics, such as content upload totals, by monitoring the various client devices. A rewards manager of the tracking server actively encourages content transfers between the client devices by generating specific client rewards to appropriate the client devices based upon pre-defined client statistics gathered from the client devices.

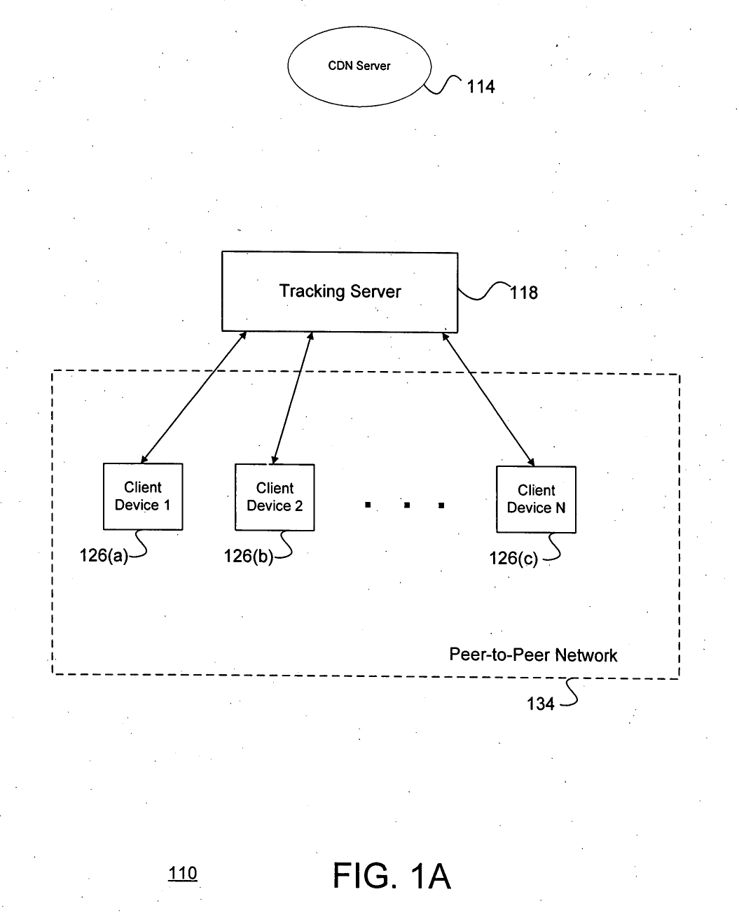

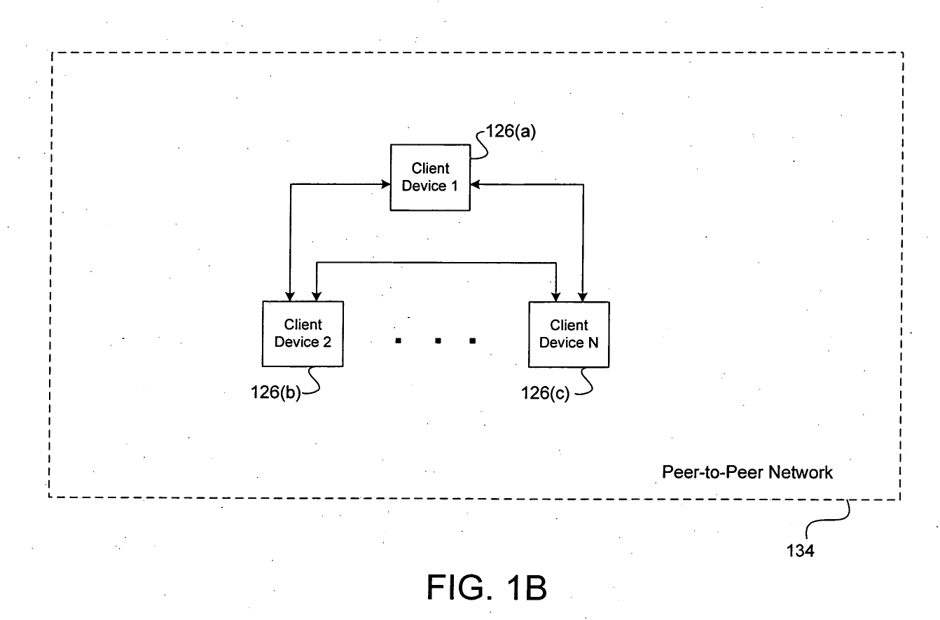

Referring now to FIG. 1A, a block diagram of an electronic network 110 is shown, in accordance with one embodiment of the present invention. In the FIG. 1A embodiment, electronic network 110 may include, but is not limited to, a content distribution network (CDN) server 114, a tracking server 118, and a plurality of client devices 126. In alternate embodiments, electronic network 110 may be implemented by utilizing components and configurations in addition to, or instead of, certain of those components and configurations discussed in conjunction with the FIG. 1A embodiment.

In accordance with the present invention, any desired number of client devices 126 may be configured in a peer-to-peer network 134 that is further discussed below in conjunction with FIG. 1B. In the FIG. 1A embodiment, client devices 126 may include an electronic device 1 (126(a)) through an electronic device N 126(c). In the FIG. 1A embodiment, each of the client devices 126 may bi-directionally communicate directly with other ones of the client devices 126 by utilizing any appropriate peer-to-peer communication techniques or other effective communication methods.

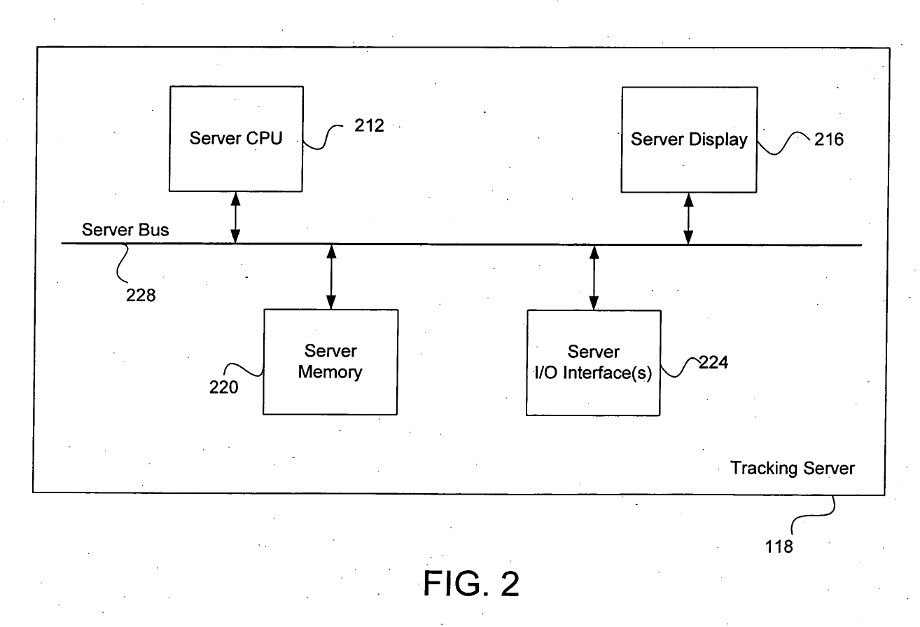

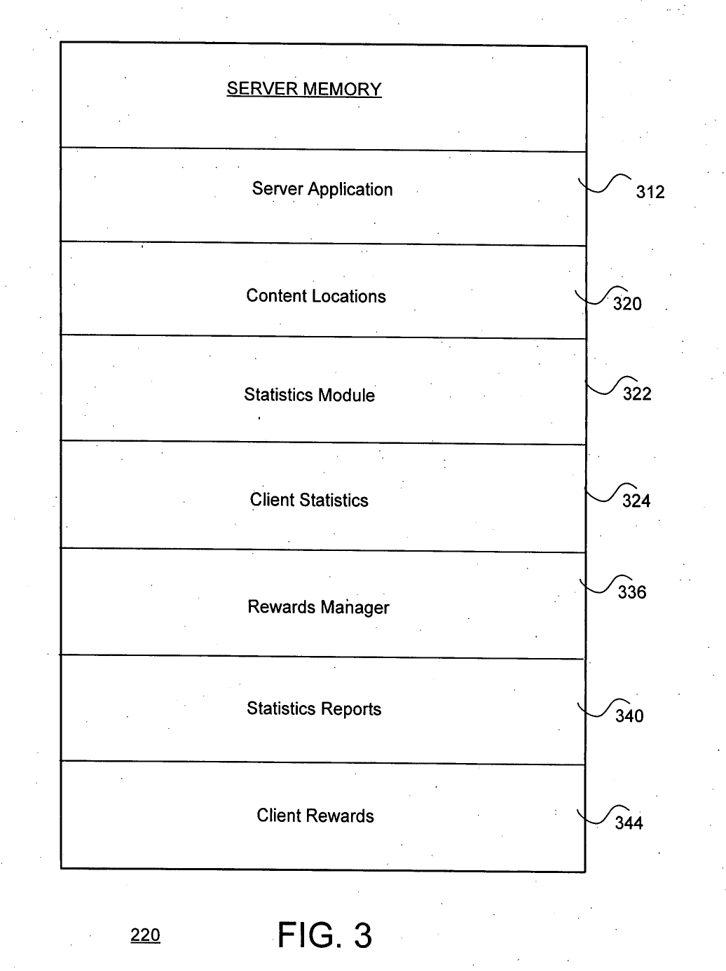

In accordance with the present invention, some or all of the client devices 126 may be advantageously preloaded with various pre-determined content items. The content items may include any desired types of electronic information. For example, content items may include, but are not limited to, entertainment programming, movies, video data, audio data, digital photographs, still image data, graphics, web pages, program guide information, and various types of software programs, etc. System users may thus perform appropriate content transfer procedures through peer-to-peer network 134 to access and utilize desired content items. In the FIG. 1A embodiment, tracking server 118 may be implemented in any effective manner to track the current locations of the various content items. One implementation for tracking server 118 is further discussed below in conjunction with FIGS. 2-3.

In the FIG. 1A embodiment, CDN server 114 may be implemented as any appropriate entity for providing any desired type of content data or other information. For example, in certain embodiments, CDN server 114 may be operated by a content management entity that produces or obtains the content data from any number of different content sources. In the FIG. 1A embodiment, in return for viewing or otherwise utilizing any transferred content items that are received from CDN server 114, a device user must pay CDN server 114 a relatively high content usage fee for the particular transferred content items. The device user may utilize a corresponding client device 126 to login to CDN server 114 or other appropriate payment service, and then make an online client payment to CDN server 114 for utilizing the particular content items.

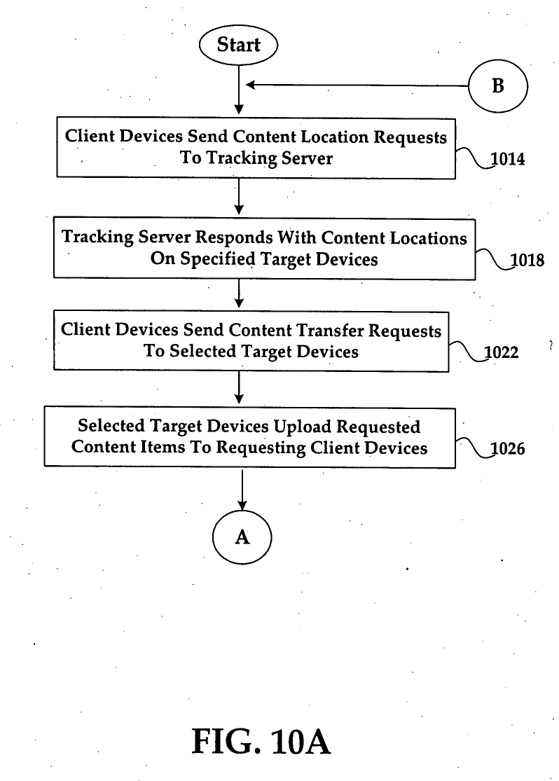

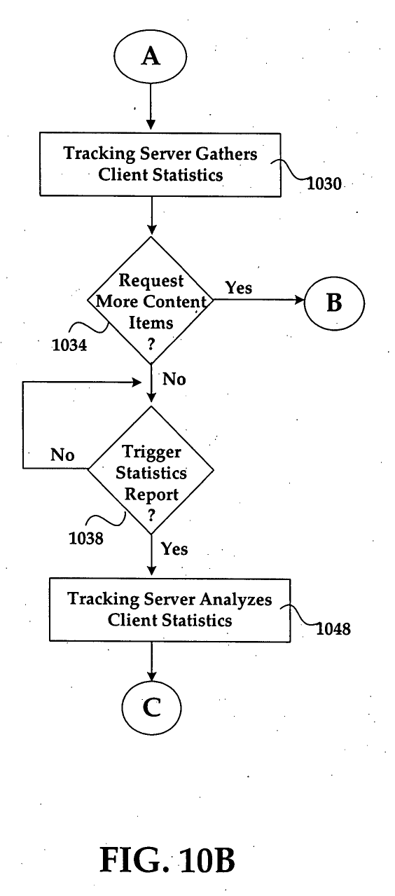

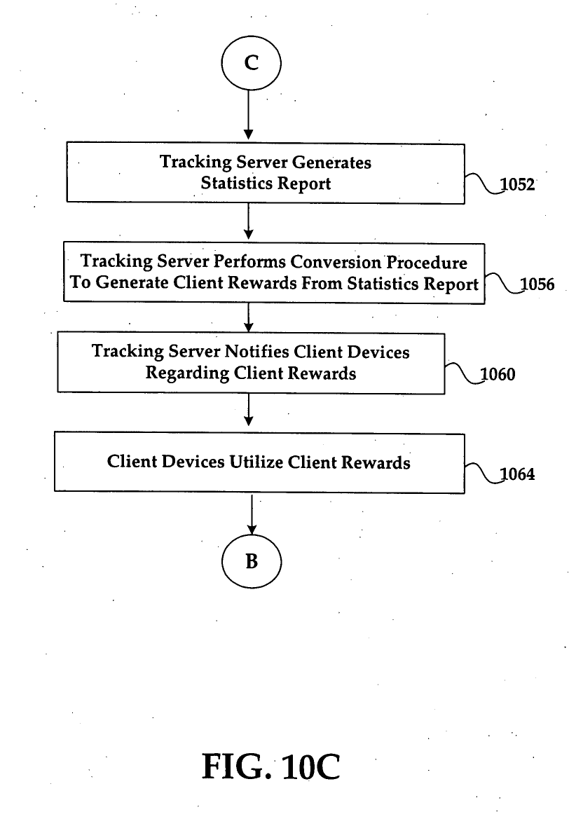

However, in the case of peer-to-peer transfer procedures, client devices 126 advantageously do not have to pay CDN server 114 a content downloading fee for the peer-to-peer transfers. Peer-to-peer transfer procedures thus provide a more economical leveraging technique for disseminating content items to the various client devices 126. However, in order for peer-to-peer transfers to occur, the various client devices 126 must be powered-up and ready to upload requested content items to other requesting client devices. The present invention therefore provides certain specific incentives to the various users of the client devices 126 in the form of client rewards for allowing their respective client devices 126 to remain in a powered-up state. Additional details regarding techniques for facilitating content transfers between the client devices 126 are further discussed below in conjunction with FIGS. 10A-10C.

Referring now to FIG. 1B, a block diagram of the FIG. 1A peer-to-peer network 134 is shown, in accordance with one embodiment of the present invention. The FIG. 1B embodiment includes a client device 1 (126(a)), a client device 2 (126(b)), through a client device N (126(a)). In alternate embodiments, peer-to-peer network 134 may be implemented by utilizing components and configurations in addition to, or instead of, certain of those components and configurations discussed in conjunction with the FIG. 1B embodiment. Furthermore, peer-to-peer network 134 may be implemented to include any desired number of client devices 126.

In the FIG. 1B embodiment, each of the client devices 126 may bi-directionally communicate directly with any other of the client devices 126 by utilizing any desired peer-to-peer communication techniques or other effective communication methods. For example, client device 1 (126(a)) may bi-directionally communicate directly with either client device 2 (126(b)) or client device N (126(c)). Similarly, client device 2 (126(b) may bi-directionally communicate directly with client device N (126(c)). Furthermore, in the FIG. 1B embodiment, any of the client devices 126 in peer-to-peer network 134 may perform a peer-to-peer content transfer procedure to transfer content items to any of the other client devices 126 in peer-to-peer network 134. Additional details regarding the utilization of the FIG. 1B peer-to-peer network 134 are further discussed below in conjunction with FIGS. 10A-10C.

Referring now to FIG. 2, a block diagram for one embodiment of the FIG. 1A tracking server 118 is shown, in accordance with the present invention. In the FIG. 2 embodiment, tracking server 118 includes, but is not limited to, a server central processing unit (server CPU) 212, a server display 216, a server memory 220, and one or more server input/output interface(s) (server I/O interface(s)) 224. The foregoing components of tracking server 118 may be coupled to, and communicate through, a server bus 228. In alternate embodiments, tracking server 118 may alternately be implemented using components and configurations in addition to, or instead of, certain of those components and configurations discussed in conjunction with the FIG. 2 embodiment.

In the FIG. 2 embodiment, server CPU 212 may be implemented to include any appropriate and compatible microprocessor device that preferably executes software instructions to thereby control and manage the operation of tracking server 118. The FIG. 2 server display 216 may include any effective type of display technology including a cathode-ray-tube monitor or a liquid-crystal display device with an appropriate screen for displaying various information to a server user. In the FIG. 2 embodiment, server memory 220 may be implemented to include any combination of desired storage devices, including, but not limited to, read-only memory (ROM), random-access memory (RAM), and various types of non-volatile memory, such as floppy disks, memory sticks, compact disks, or hard disks. The contents and functionality of server memory 220 are further discussed below in conjunction with FIG. 3.

In the FIG. 2 embodiment, server I/O interface(s) 224 may include one or more input and/or output interfaces to receive and/or transmit any required types of information by tracking server 118. Server I/O interface(s) 224 may include one or more means for allowing a server user to communicate with tracking server 118. The utilization of tracking server 118 is further discussed below in conjunction with FIGS. 10A-10C.

Referring now to FIG. 3, a block diagram for one embodiment of the FIG. 2 server memory 220 is shown, in accordance with the present invention. In the FIG. 3 embodiment, server memory 220 may include, but is not limited to, a server application 312, contents locations 320, statistics module 322, client statistics 324, a rewards manager 336, statistics reports 340, and client rewards 344. In alternate embodiments, server memory 220 may include various other components and functionalities in addition to, or instead of, certain those components and functionalities discussed in conjunction with the FIG. 3 embodiment.

In the FIG. 3 embodiment, server application 312 may include program instructions that are preferably executed by server CPU 212 (FIG. 2) to perform various functions and operations for tracking server 118. The particular nature and functionality of server application 312 typically varies depending upon factors such as the specific type and particular functionality of the corresponding tracking server 118. For example, in the FIG. 3 embodiment, server application 312 may monitor any transfers of content items between the various client devices 126.

Server application 312 may then dynamically update content locations 320.to incorporate any new changes in the current storage locations of the various content items on client devices 126. Content locations 320 may include, but are not limited to, the original factory preload locations of the various content items. In certain embodiments, content locations 320 may include unique content item identifiers that are associated with corresponding client device identifiers that represent the respective client devices 126 on which the content items are stored.

In the FIG. 3 embodiment, statistics module 322 may monitor and compile client statistics 324 that reflect any appropriate information and characteristics of peer-to-peer network 134 (FIG. 2). For example, client statistics 324 may include any desired type of statistical information regarding content transfer procedures for transferring content items directly between client devices 126 in peer-to-peer network 134. In certain embodiments, statistics module 322 may periodically query client devices 126 to obtain updated client statistics 324.

Alternately, client devices 126 may automatically inform statistics module 322 regarding any new content transfer procedures, and statistics module 322 may then update client statistics 324. In the FIG. 3 embodiment, client statistics 324 may be collected for each client device 126, and may include, but are not limited to, upload transfer throughput statistics, download transfer statistics, peer-to-peer transfer frequency, transferred content types, transfer target devices, transfer source devices, transferred content titles, and any other relevant statistical transfer patterns or information.

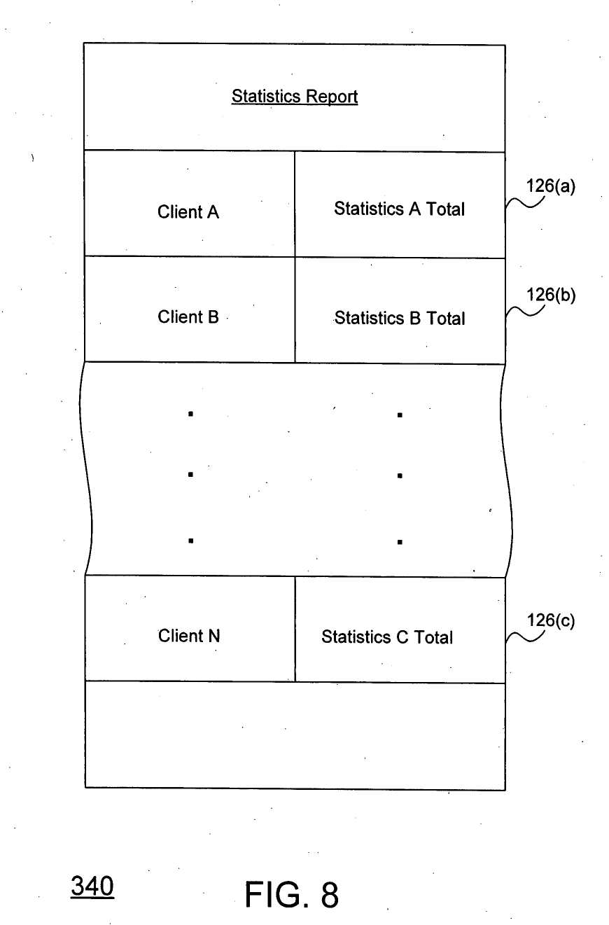

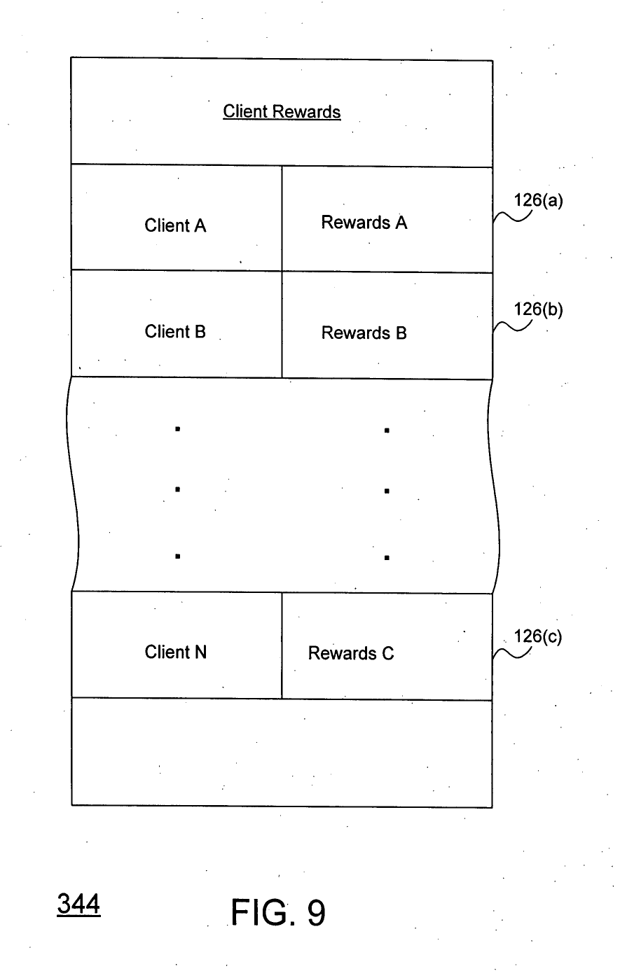

In the FIG. 3 embodiment, rewards manager 336 may analyze client statistics 324 to periodically generate corresponding statistics reports 340. Rewards manager 336 may then convert the report values from the statistics reports 340 into appropriate client rewards 344 in accordance with certain pre-defined reward rules. Additional details regarding the utilization of statistics reports 340 and client rewards 344 are further discussed below in conjunction with FIGS. 8-9.

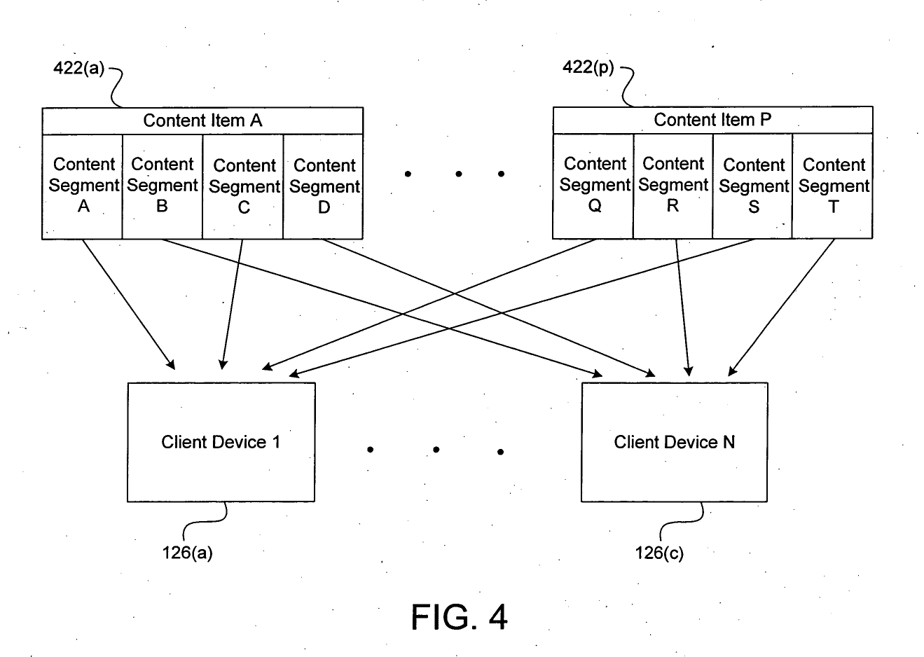

Referring now to FIG. 4, a diagram illustrating a segmented content preloading procedure is shown, in accordance with one embodiment of the present invention. The FIG. 4 example is presented for purposes of illustration, and in alternate embodiments, the present invention may perform segmented or non-segmented content preloading procedures by utilizing techniques and configurations in addition to, or instead of, certain of those techniques and configurations discussed in conjunction with the FIG. 4 embodiment.

In certain situations, manufacturers of various electronic devices may desire to preload content items 422 onto their electronic devices, and offer some of these content items without cost, so that the system users may be more likely to begin using their services. One limitation of pre-loading entire content items is the physical size of device hard disks, as well as the manufacturing time needed to image the hard disk in the factory. For example, if a manufacturer wishes to preload two high-definition movies onto an electronic device, then the required size of the hard disk to store the movies might be over 200 Gigabytes, and imaging the hard disks would be very time-consuming.

Another problem is that the manufacturer must very carefully choose which content items to pre-load. Because of the large amount of digital data involved, the limited number of content items would likely not satisfy all customers, but might be attractive only to a limited subset of system users. In addition, there are various significant security issues with pre-loaded content items, because customers may be able to extract the content items without any authorization. In certain environments, manufacturers may offer their content items by means of downloading. However, this downloading option is very expensive because of the high download fees charged by content providers.

In accordance with the FIG. 4 embodiment, instead of preloading entire content items, the present invention proposes that content items 422 be divided into any desired number of different content segments of any appropriate segment size(s). In the FIG. 4 embodiment, for purposes of illustration, the shown content items 422 are both divided into four content segments. Any desired number of different content items 422 may be utilized. In the FIG. 4 example, content item A 422(a) is divided into four content segments A through D, and content item P 422(p) is divided into four content segments Q through T. However, the number of different content segments and their corresponding segment sizes is not fixed. Also, all content items 422 need not have the same number or size of content segments. The number and size of content segments per content item 422 may be determined in any effective and optimal manner.

Segmented content preloading procedures may then performed by optimally selecting and storing a subset of content segments from the various content items 422 onto individual client devices 126. In accordance with the present invention, any desired number of client devices 126 may be utilized. All client devices 126 need not receive content segments. However, each content segment from every content item 422 is preferably preloaded onto at least one client device 126. The content segments may be mapped to corresponding client devices 126 in any effective manner. For example, in the FIG. 4 embodiment, client device 1 (126(a)) receives content segments A and C from content item A 422(a) and content segments Q and S from content item P 422(p). Similarly, client device N 126(c) receives content segments B and D from content item A 422(a) and content segments R and T from content item P 422(p). System users may then browse a complete content catalog of available content items 422 to initiate peer-to-peer transfers for obtaining required content segments for the content items 422 of their choice.

In accordance with the foregoing segmented content preloading procedure, storage capacity (hard disk size) of the client devices 126 does not pose a serious limitation because only a relatively small content segment from every content item 422 is pre-loaded. High-definition content (with greater amounts of image data) may thus be more effectively supported. In addition, the preloaded content may now be personalized to individual user tastes because system users may flexibly select from an extensive content catalogue of contents items, instead of just a few content items that were preloaded in their entirety. With regard to content security issues, the preloaded content segments can not be used to assemble complete content items 422 because initially there are many content segments that are missing from any given client device 126.

In addition, a complete set of content segments from the content items 422 is preloaded in a distributed manner to the various client devices 126. There is therefore no need for downloading content from content providers, and thus no expensive download fees. Furthermore, as new content items become available, corresponding new content segments may be preloaded onto new client devices 126 for subsequent dissemination to other client devices 126 through peer-to-peer network 134.

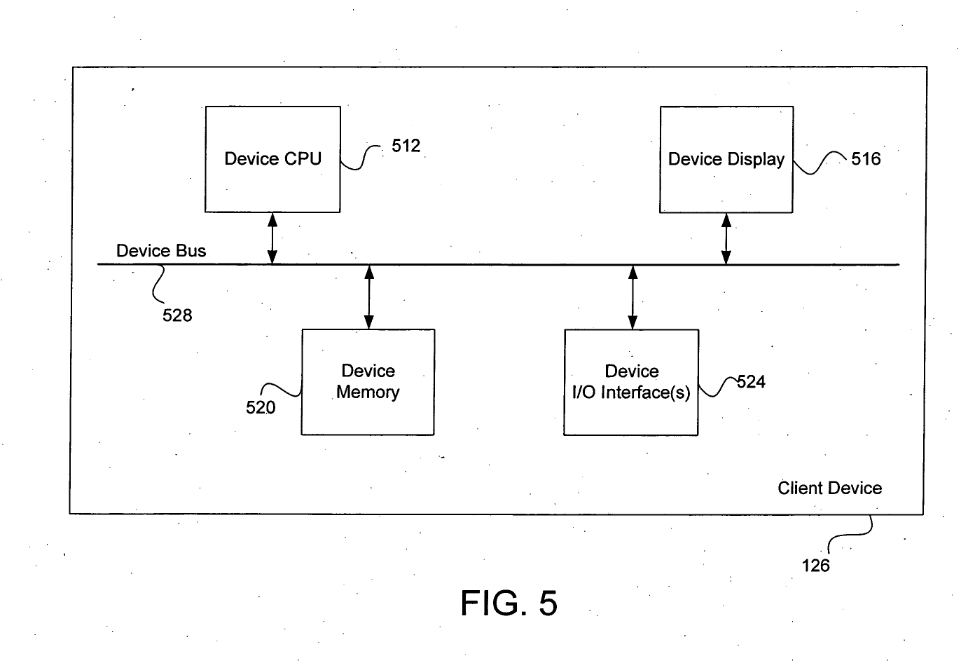

Referring now to FIG. 5, a block diagram for one embodiment of a FIG. 1A client device 126 is shown, in accordance with the present invention. In the FIG. 5 embodiment, client device 126 may include, but is not limited to, a device central processing unit (device CPU) 512, a device display 516, a device memory 520, and one or more device input/output interface(s) (device I/O interface(s)) 524. The foregoing components of client device 126 may be coupled to, and communicate through, a device bus 528.

In alternate embodiments, client device 126 may readily be implemented using various components and configurations in addition to, or instead of, certain of those components and configurations discussed in conjunction with the FIG. 5 embodiment. Furthermore, in the FIG. 5 embodiment, client device 126 may be implemented as any type of appropriate electronic device. For example, in certain embodiments, client device 126 may be implemented as any type of stationary or portable electronic device, such as a personal computer, a television, a consumer-electronics device, a cellular telephone, a settop box, an audio-visual entertainment device, or a personal digital assistant (PDA).

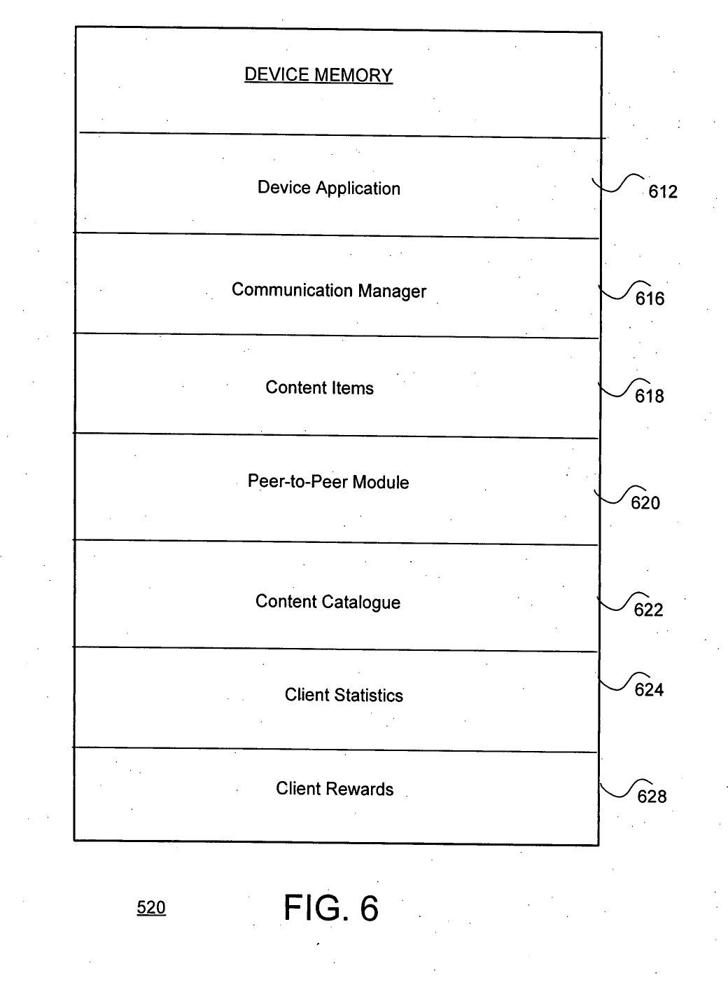

In the FIG. 5 embodiment, device CPU 512 may be implemented to include any appropriate and compatible microprocessor device that preferably executes software instructions to thereby control and manage the operation of client devices 126. The FIG. 5 device display 516 may include any effective type of display technology including a cathode-ray-tube monitor or a liquid-crystal display device with an appropriate screen for displaying various information to a device user. In the FIG. 5 embodiment, device memory 520 may be implemented to include any combination of desired storage devices, including, but not limited to, read-only memory (ROM), random-access memory (RAM), and various types of non-volatile memory, such as floppy disks, memory sticks, compact disks, or hard disks. The contents and functionality of device memory 520 are further discussed below in conjunction with FIG. 6.

In the FIG. 5 embodiment, device I/O interface(s) 524 may include one or more input and/or output interfaces to receive and/or transmit any required types of information by client device 126. Device I/O interface(s) 524 may include one or more means for allowing a device user to communicate with other entities in electronic network 110 (FIG. 1A). For example, the foregoing means may include a keyboard device, a wireless remote-control device, a speech-recognition module with corresponding microphone, a graphical user interface with touch-screen capability, a hand-held device controller unit, or a selection button array mounted externally on client device 126. The implementation and utilization of client device 126 are further discussed below in conjunction with FIGS. 10A-10C.

Referring now to FIG. 6, a block diagram for one embodiment of the FIG. 5 device memory 520 is shown, in accordance with the present invention. In the FIG. 6 embodiment, device memory 520 includes, but is not limited to, a device application 612, a communications manager 616, content items 618, a peer-to-peer module 620, a content catalogue 622, client statistics 624, and client rewards 628. In alternate embodiments, device memory 520 may include various other components and functionalities in addition to, or instead of, certain of those components and functionalities discussed in conjunction with the FIG. 6 embodiment.

In the FIG. 6 embodiment, device application 612 may include program instructions that are preferably executed by a device CPU 512 (FIG. 5) to perform various functions and operations for a client device 126. The particular nature and functionality of device application 612 typically varies depending upon factors such as the specific type and particular functionality of the corresponding client device 126.

In the FIG. 6 embodiment, communication manager 616 may perform communication procedures for exchanging electronic information with external entities by utilizing any appropriate techniques. For example, communication manager 616 may bi-directionally communicate with tracking server 118 to obtain current location information for specific required content segments 618. In the FIG. 6 embodiment, content items 618 may include either content items that were initially preloaded onto a client device 126 during manufacture, or content items that were subsequently received from other client devices 126.

In the FIG. 6 embodiment, peer-to-peer module 620 may be utilized by a particular client device 126 to directly communicate with any other client device 126 in peer-to-peer network 134 (FIG. 2). For example, peer-to-peer module 620 may perform a content item transfer procedure to either upload content items to, or download content items from, other client devices 126 in peer-to-peer network 134.

In the FIG. 6 embodiment, content catalogue 622 may include an extensive listing of all content items 422 that are available from client devices 126. In the FIG. 6 embodiment, client statistics 624 may include any relevant statistics or information regarding the operation of a host client device 126. In the FIG. 6 embodiment, client rewards 628 may include one or more client rewards that have been awarded to a host client device 126 by tracking server 118 or other appropriate entity. The utilization and implementation of client device 126 is further discussed below in conjunction with FIGS. 10A-10C.

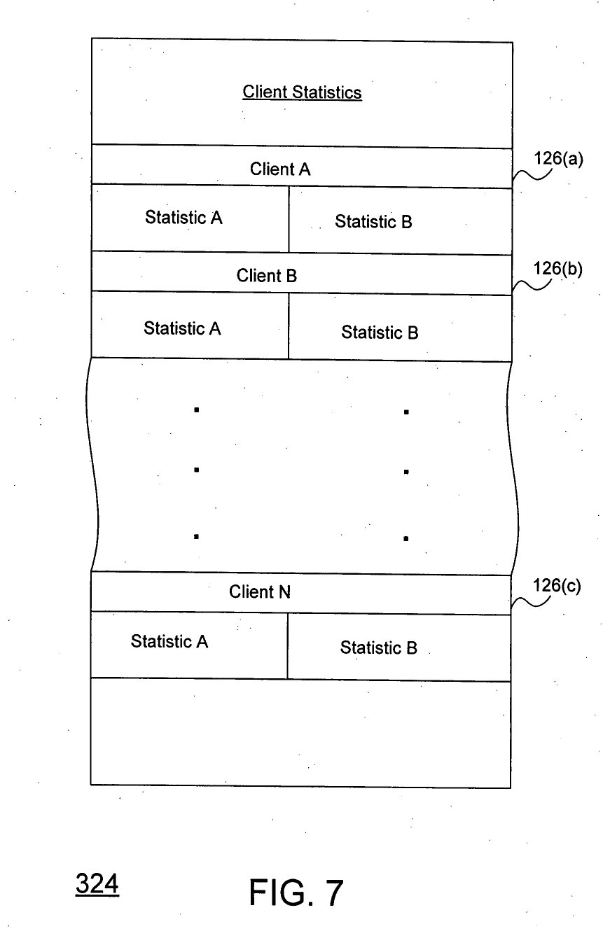

Referring now to FIG. 7, a block diagram for one embodiment of the FIG. 3 client statistics 324 is shown, in accordance with the present invention. The FIG. 7 embodiment is presented for purposes of illustration, and in alternate embodiments, client statistics 324 may include other components and information in addition to, or instead of, certain of those components and information discussed in conjunction with the FIG. 7 embodiment.

In the FIG. 7 embodiment, client statistics 324 include various predetermined types of statistics and other relevant information corresponding respectively to client device A 126(a) through client device N 126(c). For example, in the FIG. 7 embodiment, a client device A 126(a) has information corresponding to a statistic A and a statistic B. In accordance with the present invention, each client device 126 may be represented by any desired number of different individual statistics that may include any appropriate or relevant types of information.

For example, in certain embodiments, each client may be represented only by an upload throughput statistic that quantifies the number of megabytes of content items that a given client device 126 transfers to other requesting client devices 126. In certain embodiments, a device up-time statistic may be utilized to quantify a total amount of time that a corresponding client device 126 is powered-up and ready for supporting any required transfers of content items in peer-to-peer network 134. In certain embodiments, a download throughput statistic may be utilized to quantify the number of megabytes of content items that a given client device 126 receives from other client devices 126. Utilization of client statistics 324 is further discussed below in conjunction with FIGS. 10A-10C.

Referring now to FIG. 8, a block diagram for one embodiment of a FIG. 3 statistics report 340 is shown, in accordance with the present invention. The FIG. 8 embodiment is presented for purposes of illustration, and in alternate embodiments, statistics report 340 may include other components and information in addition to, or instead of, certain of those components and information discussed in conjunction with the FIG. 8 embodiment.

In the FIG. 8 embodiment, statistics report 340 includes, but is not limited to, statistics total values corresponding respectively to client A 126(a) through client N 126(c). For example, in the FIG. 8 embodiment, a client device A 126(a) has information corresponding to a statistics A total. In the FIG. 8 embodiment, tracking server 118 may periodically analyze client statistics 324 (FIG. 7) and responsively generate statistics report 340 by utilizing any effective techniques. For example, tracking server 118 may combine multiple individual client statistics 324 for a given client device by utilizing a weighted or unweighted summing technique. In the case of a weighted sum, individual weighting values may be selected to provide priority levels for individual client statistics.

In certain embodiments, statistics report 340 may include more than one statistics total value for a given client device 126. For example, in certain embodiments, each of the client devices 126 may be represented by individual statistics totals that are itemized according to the different types of client statistics that are being monitored. Utilization of statistics report 340 is further discussed below in conjunction with FIGS. 10A-10C.

Referring now to FIG. 9, a block diagram for one embodiment of the FIG. 3 client rewards 344 is shown, in accordance with the present invention. The FIG. 9 embodiment is presented for purposes of illustration, and in alternate embodiments, client rewards 344 may include other components and information in addition to, or instead of, certain of those components and information discussed in conjunction with the FIG. 9 embodiment.

In the FIG. 9 embodiment, client rewards 344 include, but are not limited to, individual client rewards (A through C) corresponding respectively to client A 126(a) through client N 126(c). For example, in the FIG. 9 embodiment, a client device A 126(a) has information corresponding to client rewards A. In the FIG. 9 embodiment, a rewards manager 336 (FIG. 3) of tracking server 118 calculates the specific values for client rewards 344 by referencing statistics report 340 or by directly utilizing information from client statistics 324. In the FIG. 9 embodiment, client rewards 344 may be determined by utilizing any effective methods.

For example, in certain embodiments, rewards manager 336 may utilize a predefined lookup table to convert appropriate elements from either statistics report 340 or client statistics 324 into corresponding client rewards 344. Alternately, rewards manager 336 may utilize an updatable algorithm to calculate client rewards 344 based upon current incentive priorities and performance criteria in peer-to-peer network 134. In the FIG. 9 embodiment, rewards manager 336 preferably generates a new statistics report 340 and calculates corresponding client rewards 344 at a selectable periodic frequency (daily, weekly, monthly, etc.).

In the FIG. 9 embodiment, the magnitude of the respective client rewards 344 is preferably proportional to the magnitude of corresponding predetermined client statistics 324 or statistics totals from statistics report 340. For example, in certain embodiments, client rewards 344 may be directly proportional to the number of megabytes of content items that a given client device 126 uploads to other client devices 126. In the FIG. 9 embodiment, client rewards 344 may be implemented to include any appropriate type of entity or object.

For example, client rewards 344 may include, but are not limited to, specific monetary rewards, and/or discount coupons or credits for any type of desired purchase (including purchase of downloaded content items from either CDN server 114 or other client devices 126 in peer-to-peer network 134). In addition, client rewards 344 may be implemented in either an electronic format or in a physical format. In the FIG. 9 embodiment, tracking server 118 may award the client rewards 344 to the respective client devices 126 in any effective manner.

For example, tracking server 118 may notify the client devices 126 regarding client rewards 344 by sending a electronic message (such as an email) to the appropriate client devices 126. In addition, in certain embodiments, tracking server 118 may transfer an electronic or physical rewards certificate to the respective client devices 126. In the FIG. 9 embodiment, tracking server 118 preferably monitors and updates the individual reward values in client rewards 344 after client devices 126 utilize/spend their respective client rewards 344. Generation of client rewards is further discussed below in conjunction with FIGS. 10A-10C.

Referring now to FIGS. 10A, 10B, and 10C, a flowchart of method steps for facilitating content transfers between client devices is shown, in accordance with one embodiment of the present invention. The flowchart of FIGS. 10A-10C is presented for purposes of illustration, and in alternate embodiments, the present invention may utilize steps and sequences other than those steps and sequences discussed in conjunction with the FIGS. 10A-10C.

In the FIG. 10A embodiment, in step 1014, one or more requesting client devices 126 send corresponding content location requests to a tracking server 118. In step 1018, the tracking server 118 responds by returning content locations 320 on specified target client devices 126 to the requesting client devices 126. In step 1022, the requesting client devices 122 then send content transfer requests for the desired content items to selected target client devices 126. In step 1026, the selected target client devices 126 responsively upload the requested content items to the requesting client devices 126. The FIG. 10A process then advances to step 1030 of FIG. 10B through connector A.

In step 1030 of the FIG. 10B embodiment, a statistics module 322 of tracking server 118 gathers client statistics 324 from the various client devices 126. The client statistics 324 may include any relevant information including, but not limited to, the number of megabytes of content information uploaded from a given client device 126 to other client devices 126. In step 1034, if device users of the various client devices 126 want to request more content items, then FIG. 10B process may return to step 1014 of FIG. 10A through connector B, where additional content transfers may then occur.

In step 1038, a rewards manager 336 of tracking server 118 may determine whether to trigger a statistics report 340. In certain embodiments, rewards manager 336 may periodically trigger statistics reports 340 at predetermined and selectable time intervals. In step 1048, if a statistics report 340 is triggered, then rewards manager 336 analyzes the information currently compiled in client statistics 324. The FIG. 10B process then advances to step 1052 of FIG. 10C through connector C.

In step 1052 of the FIG. 10C embodiment, rewards manager 336 of tracking server 118 generates a statistics report 340 based upon information gathered and stored in client statistics 324. Then, in step 1056, rewards manager 336 of tracking server 118 performs a conversion procedure to generate specific client rewards 344 from the information represented in the statistics report 340. In step 1060, rewards manager 336 of tracking server 118 notifies the respective client devices regarding their individual client rewards 344. Finally, in step 1064, device users of the various client devices 126 may utilize their respective client rewards 344 in any desired manner. For at least the foregoing reasons, the present invention therefore provides an improved system and method for facilitating content transfers between client devices in an electronic network.

The invention has been explained above with reference to certain embodiments. Other embodiments will be apparent to those skilled in the art in light of this disclosure. For example, the present invention may readily be implemented using certain configurations and techniques other than those described in the specific embodiments above. Additionally, the present invention may effectively be used in conjunction with systems other than those described above. Therefore, these and other variations upon the discussed embodiments are intended to be covered by the present invention, which is limited only by the appended claims.

What is claimed is:

1. A system for facilitating content transfers in an electronic network, comprising:
client devices that are configured to perform said content transfers for exchanging content items in said electronic network; and
a rewards manager that generates client rewards to said client devices based upon client statistics gathered from said client devices.

2. The system of claim 1 wherein said rewards manager resides on a tracking server that monitors content locations of said content items on said client devices.

3. The system of claim 2 wherein requesting client devices send content location requests to said tracking server to locate said content items on said electronic network.

4. The system of claim 3 wherein said tracking server returns content locations on target client devices to said requesting client devices in response to said content location requests.

5. The system of claim 4 wherein said requesting client devices send content transfer requests for selected ones of said content items to said target client devices.

6. The system of claim 5 wherein said target client devices upload said selected ones of said content items to said requesting client devices.

7. The system of claim 2 wherein a statistics module of said tracking server tabulates said client statistics received from said client devices.

8. The system of claim 7 wherein said client statistics include a total upload throughput value for each of said client devices, and a device uptime value for each of said client devices.

9. The system of claim 2 wherein said rewards manager generates a statistics report that summarizes said client statistics for each of said client devices.

10. The system of claim 9 wherein said rewards manager periodically triggers said statistics report at a predetermined and selectable time interval.

11. The system of claim 10 wherein said rewards manager generates said statistics report based upon analyzing client information gathered and stored in said client statistics.

12. The system of claim 11 wherein said rewards manager combines said client statistics to generate corresponding statistics totals to populate said statistics report.

13. The system of claim 12 wherein said rewards manager derives said statistics totals by calculating a weighted sum of said client statistics for each of said client devices.

14. The system of claim 2 wherein said rewards manager performs a conversion procedure to produce said client rewards from said statistics report, said conversion procedure utilizing at least one of a lookup table and a conversion algorithm for generating said client rewards from said statistics report.

15. The system of claim 1 wherein said client rewards include electronic discount coupons for purchasing downloaded content items.

16. The system of claim 1 wherein said rewards manager notifies said client devices regarding said client rewards by sending award messages over said electronic network.

17. The system of claim 2 wherein said client devices and said tracking server are configured in a peer-to-peer network that supports direct bi-directional communications between any of said tracking server and said client devices.

18. The system of claim 1 wherein said content items include entertainment programming, movies, video data, audio data, digital photographs, still image data, graphics, web pages, program guide information, and software programs.

19. A method for facilitating content transfers in an electronic network, comprising the steps of:
utilizing client devices to perform said content transfers for exchanging content items through said electronic network; and
generating client rewards from a rewards manager to said client devices based upon client statistics gathered from said client devices.

20. A system for facilitating content transfers in an electronic network, comprising:
means for exchanging content items over said electronic network by performing said content transfers; and
means for generating client rewards to said client devices based upon client statistics gathered from said client devices.
